(19) United States
(12) Patent Application Publication
(10) Pub. No.: US 2011/0067450 A1
(43) Pub. Date: Mar. 24, 2011

(54) METHOD AND APPARATUS FOR FORMING SHAPED ARTICLES FROM SHEET MATERIAL

(76) Inventors: Allan Mark Fredholm, Vulaines-sur-Seine (FR); Christophe Pierron, Avon (FR); Patrick Jean Pierre Herve, Avon (FR); Thierry Luc Alain Dannoux, Avon (FR)

(21) Appl. No.: 12/565,301

(22) Filed: Sep. 23, 2009

(51) Int. Cl. C03B 9/00; C03B 23/00

(52) U.S. Cl. 65/81; 65/286

(57) ABSTRACT

An apparatus for making shaped articles includes a container having at least one vacuum port and a surface for receiving a sheet of glass-based material. At least one positive mold is supported in the container, where the at least one positive mold has an exterior surface including a profile defining an interior of a shaped article. An open volume is defined between the container and the at least one positive mold and is in communication with the vacuum port.

### PRIORITY

The application claims the priority and benefit of PCT Application No. PCT/IB2008/003701 titled “Method and Apparatus for Forming Shaped Materials from Sheet Material” filed on Nov. 26, 2008 in the name of inventors Allan Mark Fredholm, Christophe Pierron, Patrick Jean Pierre Herve and Thierry Luc Alain Dannoux.

### FIELD

The invention relates generally to methods and apparatus for forming shaped articles. More specifically, the invention relates to a method and an apparatus for forming a shaped glass-based article which may have a thin wall.

### BACKGROUND

Molding is a common technique used to make shaped objects. Precision molding is suitable for forming shaped glass articles, particularly when the final glass article is required to have a high dimensional accuracy and a high-quality surface finish. In precision molding, a glass preform having an overall geometry similar to that of the final glass article is pressed between a pair of mold surfaces to form the final glass article. The process requires high accuracy in delivery of the glass preform to the molds as well as precision ground and polished mold surfaces and is therefore expensive. Press molding based on pressing a gob of molten glass into a desired shape with a plunger can be used to produce shaped glass articles at a relatively low cost, but generally not to the high tolerance and optical quality achievable with precision molding. Where the molten glass has to be spread thinly to make a thin-walled glass article having complex curvatures, the molten glass may become cold, or form a cold skin, before reaching the final desired shape. Shaped glass articles formed from press molding a gob of molten glass may exhibit one or more of shear marking, warping, optical distortion due to low surface quality, and overall low dimensional precision. Shaped glass articles have also been formed by pressing glass plates into molds.

### SUMMARY

In one aspect, the invention relates to a method of making shaped articles which comprises providing a container containing an array of spaced-apart positive molds, each of the positive molds having an exterior surface including a profile defining an interior of a shaped article. The method further includes positioning a sheet of glass-based material on the container such that a closed volume is defined between the sheet and the container, and the closed volume encloses the array of spaced-apart positive molds. The method includes applying vacuum to the closed volume and sagging the sheet by vacuum onto the exterior surfaces of the positive molds and into spaces between the positive molds to form an array of shaped articles interconnected by sagging webs in a portion of the sheet, where the sagging webs extend below a base of the array of shaped articles. The method includes separating the array of shaped articles from the positive molds and trimming off the sagging webs to separate the array of shaped articles into individual shaped articles.

In another aspect, the invention relates to an apparatus for making shaped articles which comprises a container having at least one vacuum port and a surface for receiving a sheet of glass-based material. The apparatus includes at least one positive mold supported in the container, where the at least one positive mold has an exterior surface including a profile defining an interior of a shaped article. The apparatus includes an open volume defined between the container and the at least one positive mold. The open volume is in communication with the vacuum port.

Other features and advantages of the invention will be apparent from the following description and the appended claims.

### BRIEF DESCRIPTION OF DRAWINGS

The accompanying drawings, described below, illustrate typical embodiments of the invention and are not to be considered limiting of the scope of the invention, for the invention may admit to other equally effective embodiments. The figures are not necessarily to scale, and certain features and certain views of the figures may be shown exaggerated in scale or in schematic in the interest of clarity and conciseness.

FIG. 1 is a top view of an apparatus for making shaped articles.

FIG. 2 is a cross-section of FIG. 1 taken along line 2-2.

FIG. 3 is a perspective view of a positive mold.

FIG. 4 shows a sheet of material suspended over an apparatus for making shaped articles.

FIG. 5 shows the sheet of FIG. 4 positioned on the container of the apparatus.

FIG. 6 shows the sheet of FIG. 5 sagged onto positive molds.

FIG. 7 shows a force applied to a web in the sheet of FIG. 6.

FIG. 8 is a partial array of interconnected shaped articles.

FIG. 9 shows individual shaped articles.

### DETAILED DESCRIPTION

The invention will now be described in detail with reference to a few embodiments, as illustrated in the accompanying drawings. In describing the embodiments, numerous specific details are set forth in order to provide a thorough understanding of the invention. However, it will be apparent to one skilled in the art that the invention may be practiced without some or all of these specific details. In other instances, well-known features and/or process steps have not been described in detail so as not to unnecessarily obscure the invention. In addition, like or identical reference numerals are used to identify common or similar elements.

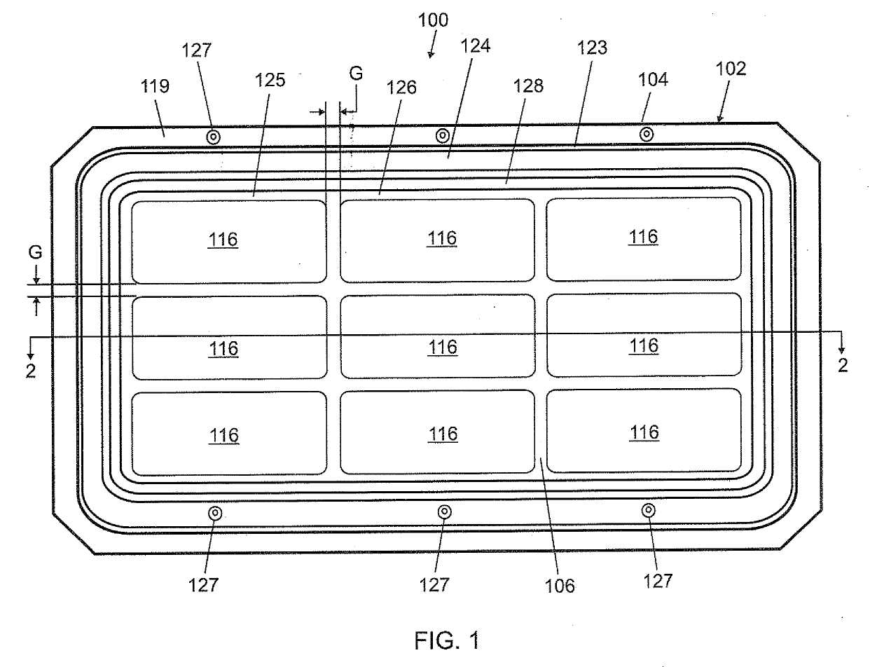

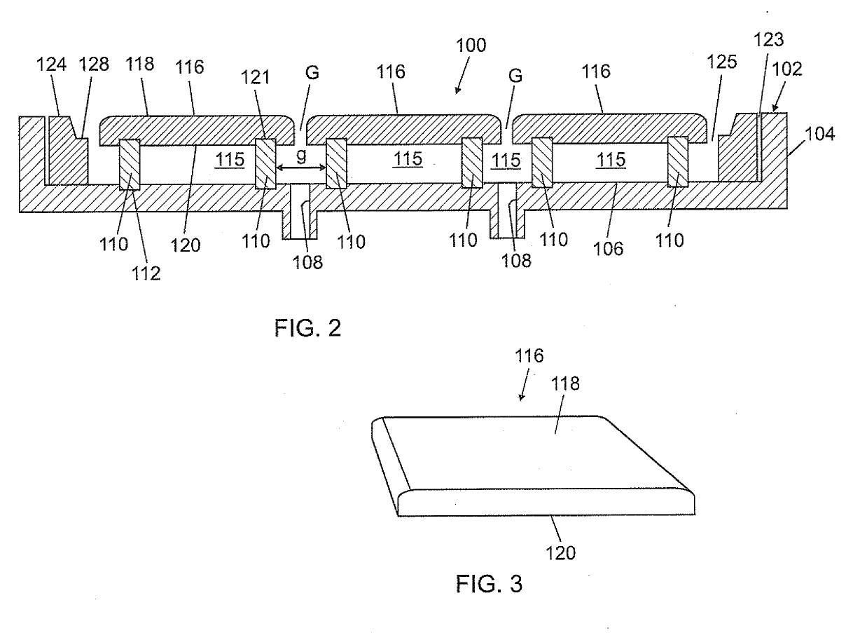

FIG. 1 is a top view of an apparatus 100 for making shaped articles. The shaped articles may be made from a glass-based material, such as glass or glass-ceramic. Apparatus 100 includes a container 102 having a side wall 104 and base wall 106. Container 102 may be made of a heat-resistant, sturdy material. FIG. 2 is a vertical cross-section of apparatus 100. As shown in FIG. 2, the container 102 includes vacuum ports 108. In general, the container 102 may have one or more vacuum ports 108. The vacuum ports 108 may be located in the base wall 106, as shown, and/or may be located in the side wall 104.

Referring to FIGS. 1 and 2, a plurality of positive molds 116 is supported in the container 102. In general, one or more positive molds 116 may be supported in the container 102. The positive molds 116 may be arranged such that there is a gap G between each positive mold 116 and its neighboring positive molds. The width of gap G may be the same or different across the apparatus. The shape of each positive mold 116 will depend on the desired shaped article to be formed by the positive mold. For illustration purposes, FIG. 3 shows an example of a positive mold 116 for forming a shaped article. The positive mold 116 has an exterior surface 118, which includes a profile of the interior of the shaped article to be formed by the positive mold 116. The mold 116 is described as “positive” because the exterior surface 118 which bears the profile of the shaped article is generally concave. The exterior surface 118 may be smooth or textured. The positive mold 116 also has a base surface 120, which may be arranged on a support as will be explained below.

Returning to FIGS. 1 and 2, the positive molds 116 may be made of a heat-resistant material, preferably one that would not react with the glass-based material that will be used in making the shaped articles under the conditions at which the shaped articles would be made. Such conditions will become apparent during subsequent descriptions of how the shaped articles are made using the apparatus. As an example, the positive molds 116 may be made of high-temperature steel, cast iron, or ceramic. To extend the life of the mold, the exterior surfaces 118 of the positive molds 116 may be coated with a hard heat-resistant material that would not react with the glass-based material that will be used in making the shaped articles. An example of such a material is diamond chromium coating.

Referring to FIG. 2, the positive molds 116 are supported on a plurality of pillars 110. The pillars 110 are supported on the base wall 106 of the container 102. The base wall 106 may include recesses 112 for receiving an end of the pillars 110. The positive molds 116 may similarly include recesses 121 for receiving an end of the pillars 110. The pillars 110 may have a circular cross-section or other type of cross-section, e.g., elliptical or annular. The size, e.g., diameter, of the pillars 110 may be the same or may be different across the apparatus. The pillars 110 may be arranged such that there is a gap g between each pillar 110 and its neighboring pillars. The width of gap g may be the same or vary across the apparatus. The pillars 110 may be made of a heat-resistant sturdy material.

Referring to FIGS. 1 and 2, in one example, a spacer ring 124 is disposed in an annular gap 123 between the side wall 104 of the container 102 and the positive molds 116. The spacer ring 124 is spaced from the positive molds 116 such that an annular gap 125 is formed between the spacer ring 124 and the positive molds 116. As more clearly shown in FIG. 2, the spacer ring 124 may include a stop 128, which is a surface that can oppose a force between the spacer ring 124 and the positive molds 116, as will be explained below.

Referring to FIG. 1, the container 102 provides a surface 119 on which a sheet of glass-based material can be positioned. In one example, ejectors 127 are located on the surface 119. The ejectors 127 may be operated to assist in unloading a sheet of glass-based material from the container 102.

Referring to FIG. 2, an open volume, generally identified at 115, is defined between the container 102 and the positive molds 116. The volume 115 is “open” because of the gaps G between the positive molds 116 and the gaps g between the pillars 110. The open volume 115 is in communication with the vacuum ports 108. The annular gap 125 may also contribute to the openness of the open volume 115 where the annular gap 125 is interconnected with the gaps G and g. If the annular gap 125 is not interconnected with the gaps G and g, a separate vacuum circuit may be connected to the annular gap 125 for providing vacuum in the annular gap 125.

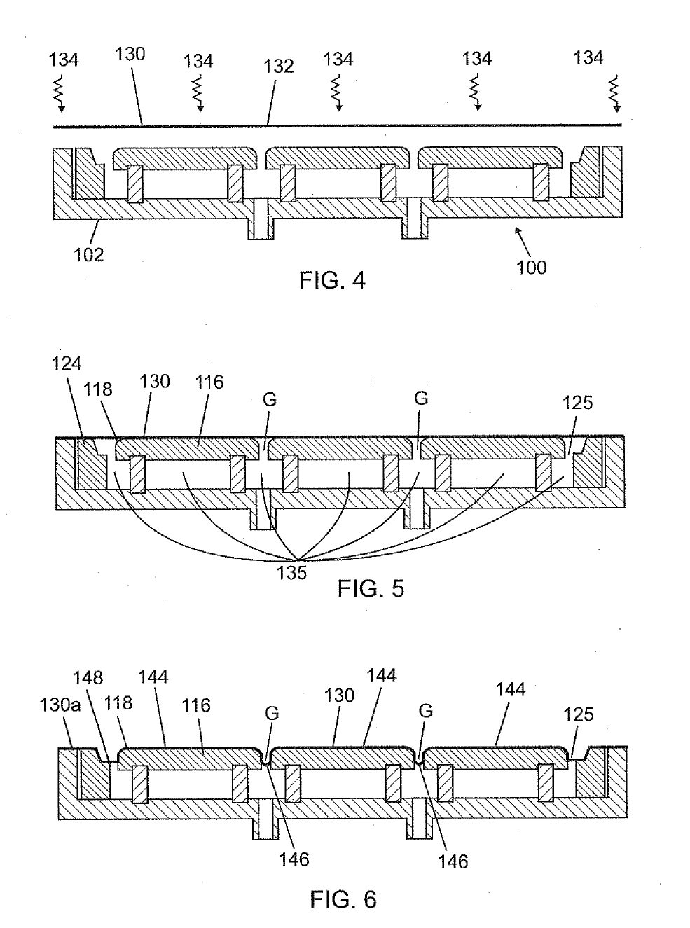

FIGS. 4-9 illustrate a method of making shaped articles. In FIG. 4, a sheet 130 made of a glass-based material is suspended over the container 102 of apparatus 100. The sheet 130 may be suspended over the container 102 using any suitable method, such as by suction cups. The suction cups or other gripping device may be applied from above, below, or at the edges of the sheet 130. Where the top surface 132 of the sheet 130 is pristine, the suction cups or other gripping device may contact the top surface 132 near the edges of the sheet 130 that will not be formed into shaped articles. The sheet 130 may be transported to the container 102 from a sheet forming station using any suitable translation device, such as a set of rollers. The sheet 130 may be made by any suitable process, such as fusion draw process or float glass process. The sheet 130 may be transported to the container 102 as a discrete sheet or as a continuous sheet. The sheet 130 may have one pristine surface or two pristine surfaces. A sheet 130 having pristine surface(s) can be made, for example, by a fusion draw process.

The material of sheet 130 may be any glass-based composition suitable for the application in which the shaped articles are to be used. The glass-based material may be glass or glass-ceramic. In one example, the glass-based material is a glass composition that is capable of being chemically strengthened by ion-exchange. Typically, the presence of small alkali ions such as Li⁺ and Na⁺ in the glass structure that can be exchanged for larger alkali ions such as K⁺ render the glass composition suitable≦for chemical strengthening by ion-exchange. The base glass composition can be variable. For example, U.S. patent application Ser. No. 11/888213, assigned to the instant assignee, discloses alkali-aluminosilicate glasses that are capable of being strengthened by ion-exchange and down-drawn into sheets. The glasses have a melting temperature of less than about 1650° C. and a liquidus viscosity of at least 1.3×10⁵ Poise and, in one embodiment, greater than 2.5×10⁵ Poise. The glasses can be ion-exchanged at relatively low temperatures and to a depth of at least 30 μm. Compositionally the glass comprises: 64 mol %≦SiO₂≦68 mol %; 12 mol %≦Na₂O≦16 mol %; 8 mol %≦Al₂O₃≦12 mol %; 0 mol %≦B₂O₃≦3mol %; 2 mol %≦K₂O≦5 mol %; 4 mol %≦MgO≦6 mol %; and 0 mol %≦CaO≦mol %, wherein: 66 mol %≦SiO₂+B₂O₃+CaO≦69 mol %; Na₂O+K₂O+B₂O₃+MgO+CaO+SrO>10 mol %; 5 mol %≦MgO+CaO+SrO≦8 mol %; (Na₂O+B₂O₃)−Al₂O₃<2 mol %; 2 mol %≦Na₂O−Al₂O₃≦6 mol %; and 4 mol %≦(Na₂O+K₂)−Al₂O₃≦10 mol %.

In order to form the glass sheet 130 into shaped articles, the sheet 130 has to be at an elevated temperature at which it can be molded. Arrows 134 show that the sheet 130 may be heated to an elevated temperature while being suspended over the container 102. Sheet 130 may also be heated to an elevated temperature prior to being suspended over container 102. In one example, sheet 130 is heated to a temperature at which the viscosity of the glass-based material is approximately 10⁹ Poise or lower. In general, this temperature will depend on the composition of the glass-based material.

In FIG. 5, sheet 130 is brought into contact with the container 102, thereby defining a closed volume, generally identified by 135, between the container 102 and the sheet 130. The temperature of the positive molds 116 may be lower than the temperature of the sheet 130. In the position depicted in FIG. 5, the sheet 130 overlies the positive molds 116, the gaps G between the positive molds 116, and the annular gap 125 between the positive molds 116 and the spacer ring 124.

The method includes applying vacuum to the closed volume 135 through the vacuum ports 108. This can be achieved, for example, by connecting a vacuum pump to the vacuum ports 108 and using the vacuum pump to remove air and other gases from the closed volume 135. As shown in FIG. 6, application of the vacuum results in sagging of the sheet 130 onto the exterior surfaces 118 of the positive molds 116 and into the gaps G and 125. The portion of the sheet 130 sagged onto the exterior surfaces 118 forms shaped articles 144. The portion of the sheet 130 sagged into the gaps G results in sagging webs 146 (concave webs), which interconnect the shaped articles 144. In one example, the sagging webs 146 extend below a base of the array of shaped articles 144 so that they can be trimmed off, as will be further explained below, to separate the shaped articles 144 into individual pieces.

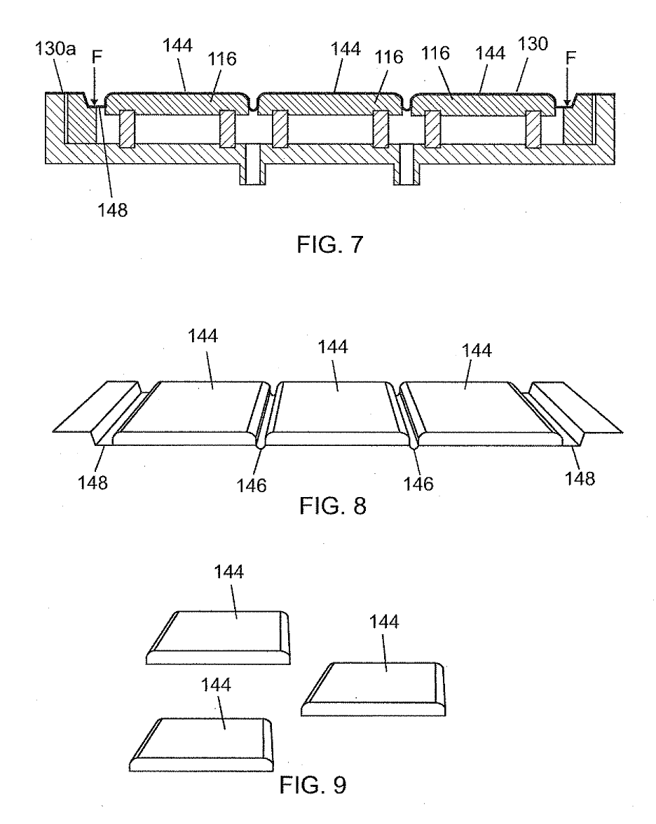

The portion of the sheet 130 sagged into the annular gap 125 results in a sagging web 148 between the shaped articles 144 (i.e., the ones adjacent to the spacer ring 124) and the remainder 130a of the sheet 130. FIG. 7 shows that a force F may be applied to the sagging web 148 either to press (thin out) the sagging web 148 or cut through the sagging web 148. In the latter case, the interconnected shaped articles 144 would be separated from the remainder 130a of the sheet 130. Force F may be applied with a tool having a blunt or sharp edge.

The method includes keeping the interconnected shaped articles 144 on the positive molds 116 until the glass-based material cools down, typically to a temperature at which the glass-based material has a viscosity of approximately 10¹³ Poise or greater. Vacuum may be maintained in the closed volume (135 in FIG. 5) while the glass-based material cools down to the desired temperature. Next, the cooled interconnected shaped articles 144 are unloaded from the positive molds 116. Unloading may include pressurizing the closed volume (135 in FIG. 5) and/or activating the ejectors (127 in FIG. 1).

FIG. 8 shows a portion of the interconnected shaped articles 144 formed as described above, after unloading from the positive molds (116 in FIG. 7). The interconnected shaped articles 144 may be annealed. After annealing, the sagging webs 146 are trimmed off to separate the shaped articles 144 into individual pieces. When the sagging webs 146 extend below the base of the shaped articles 144 as shown in FIG. 8, trimming off can be accomplished, e.g., by grinding. This avoids the use of complex machinery to dice the interconnected shaped articles 144 into individual pieces. The sagging web 148 is also trimmed off. The molding process may also be such that the sagging web 148 extends below the base of the shaped articles 144, thereby simplifying the trimming off process.

FIG. 9 shows the individual shaped articles 144. The method may include finishing the trimmed edges of the individual shaped articles 144. The method may further include chemically strengthening the shaped articles 144, as will be explained below. After chemical strengthening, techniques such as fire-polishing may be used to finish the shaped articles.

In one example, chemical strengthening is by ion-exchange. The ion-exchange process typically occurs at an elevated temperature range that does not exceed the transition temperature of the glass. The glass is dipped into a molten bath comprising a salt of an alkali metal, the alkali metal having an ionic radius that is larger than that of the alkali metal ions contained in the glass. The smaller alkali metal ions in the glass are exchanged for the larger alkali ions. For example, a glass sheet containing sodium ions may be immersed in a bath of molten potassium nitrate (KNO₃). The larger potassium ions present in the molten bath will replace smaller sodium ions in the glass. The presence of the large potassium ions at sites formerly occupied by sodium ions creates a compressive stress at or near the surface of the glass. The glass is then cooled following ion exchange. The depth of the ion-exchange in the glass is controlled by the glass composition. For potassium/sodium ion-exchange process, for example, the elevated temperature at which the ion-exchange occurs can be in a range from 390° C. to 430° C., and the time period for which the sodium-based glass is dipped in a molten bath comprising a salt of potassium can be 7 to 12 hours (less time at high temperature, more time at lower temperature). In general, the deeper the ion-exchange, the higher the surface compression and the stronger the glass can be.

The method and apparatus described above can allow forming of thin-walled shaped glass-based articles (e.g., having wall thickness <2 mm) at high precision and low cost. The exterior of the shaped articles does not come into contact with the positive molds and therefore can be pristine if the original sheet from which they are made has at least one pristine surface. The method is reproducible and consistent and flexible. Flexibility may be realized in the ability to form shaped articles with different shapes in a single process.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method of making shaped articles, comprising:
providing a container containing an array of spaced-apart positive molds, each of the positive molds having an exterior surface including a profile defining an interior of a shaped article;
positioning a heated sheet of glass-based material on the container such that a closed volume is defined between the sheet and the container, and the closed volume encloses the array of spaced-apart positive molds;
applying vacuum to the closed volume;
sagging the sheet by vacuum onto the exterior surfaces of the positive molds and into spaces between the positive molds to form an array of shaped articles interconnected by sagging webs in a portion of the sheet, said sagging webs extending below a base of the array of shaped articles;
separating the array of shaped articles from the positive molds; and
trimming off the sagging webs to separate the array of shaped articles into individual shaped articles.

2. The method of claim 1, further comprising annealing the array of shaped articles.

3. The method of claim 1, further comprising strengthening the shaped articles by ion-exchange.

4. The method of claim 1, further comprising finishing trimmed edges of the individual shaped articles.

5. The method of claim 1, further comprising heating the sheet to a temperature at which the glass-based material has a viscosity of 10⁹ Poise or lower prior to applying vacuum.

6. The method of claim 5, further comprising cooling the array of shaped articles to a temperature at which the glass-based material has a viscosity of 10¹³ Poise or greater prior to separating the array of shaped articles from the positive mold.

7. The method of claim 1, further comprising sagging the sheet by vacuum into an annular space between the positive molds and the container to form a sagging web between the array of shaped articles and another portion of the sheet.

8. The method of claim 7, further comprising pressing or cutting through the sagging web between the array of shaped articles and the another portion of the sheet.

9. The method of claim 1, further comprising coating the shaped articles with anti-smudge coating.

10. The method of claim 1, wherein the glass-based material is glass.

11. The method of claim 1, wherein the glass-based material is glass-ceramic.

12. An apparatus for making shaped articles, comprising:
a container having at least one vacuum port and a surface for receiving a heated sheet of glass-based material;
at least one positive mold supported in the container, said at least one positive mold having an exterior surface including a profile defining an interior of a shaped article; and
an open volume defined between the container and the at least one positive mold, said open volume being in communication with the vacuum port.

13. The apparatus of claim 12, further comprising at least one pillar on which the at least one positive mold is supported, the at least one pillar being disposed within the open volume.

14. The apparatus of claim 12, further comprising a spacer ring arranged between the at least one positive mold and the container.

15. The apparatus of claim 14, wherein the spacer ring comprises a surface for opposing a load applied between the at least one positive mold and the container.

16. The apparatus of claim 12, further comprising additional positive molds supported in the container, each of said additional positive molds having an exterior surface including a profile defining an interior of a shaped article, the additional positive molds and the at least one positive mold defining an array of spaced-apart positive molds.

17. The apparatus of claim 16, further comprising a plurality of spaced-apart pillars on which the array of spaced-apart positive molds are supported, the pillars being disposed within the open volume.
